(19) United States
(12) Patent Application Publication
(10) Pub. No.: US 2010/0025134 A1
(43) Pub. Date: Feb. 4, 2010

(54) ELECTRIC POWER SUPPLY SYSTEM

(75) Inventors: Kenichi Hamada, Kanagawa-ken (JP); Nobuyuki Kitamura, Yamanashi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/514,747

(22) PCT Filed: Nov. 12, 2007
(86) PCT No.: PCT/JP2007/072333

§ 371 Date: Jul. 1, 2009

(30) Foreign Application Priority Data
Nov. 13, 2006 (JP) 2006-306886

(51) Int. Cl. B60L 11/18; H02P 27/00

(52) U.S. Cl. 180/65.31; 318/400.3

(57) ABSTRACT

An electric power supply system, equipped on a mobile body to supply electric power to a drive apparatus that functions as a drive source of the mobile body, that includes a first power source apparatus that generates and supplies electric power to the drive apparatus, a second power source apparatus provided separately from the first power source apparatus and that supplies electric power to the drive apparatus, an insulation type converter provided between an electric power supply section including at least one of the first power source apparatus and the second power source apparatus, and a mobile body drive section including the drive apparatus, and ensuring insulation between these sections while transmitting electric power from the electric power supply section to the mobile body drive section. An increase in the supply voltage and adequate insulation performance can both be achieved when supplying power to a drive apparatus.

### TECHNICAL FIELD

The present invention relates to an electric power supply system that supplies electric power to a drive apparatus, for example, to a system for supplying electric power from a fuel cell that produces electric power by an electrochemical reaction to a drive apparatus.

### BACKGROUND ART

In recent years, fuel cells have drawn attention as electric power sources advantageous in operation efficiency and environment-friendliness. In a fuel cell, the amount of supplied fuel gas is controlled to output electric power as demanded. However, the output power response characteristics may sometimes be deteriorated due to a delay in response of gas supply. In view of this, in an already disclosed technology, a fuel cell and a battery (or storage battery) are connected in parallel to constitute a power source, where a combined use of the battery and fuel cell is achieved by transforming the output voltage of the fuel cell using a DC to DC converter (see, for example, Japanese Patent Application Laid-Open No. 2002-118981 and Japanese Patent Application Laid-Open No. 2000-12059).

There has also been disclosed a technology in which to drive a drive apparatus by a fuel cell, an insulation type DC to DC converter is provided between the fuel cell and the inverter of the drive apparatus, wherein the converter is configured as a bridge switching circuit and performs zero volt switching by a phase shift control so as to reduce switching noise (see, for example, Japanese Patent Application Laid-Open No. 2005-229783).

Besides the aforementioned documents, Japanese Patent Application Laid-Open No. 2005-73443 and Japanese Patent Application Laid-Open No. 2006-246617 also disclose technologies pertaining to an electric power supply system.

### DISCLOSURE OF THE INVENTION

When electric power is supplied to a drive apparatus, the amount of current supplied during the output can be decreased by increasing the supply voltage, and then consequently loss or so-called copper loss resulting from current can be decreased in the drive apparatus. Furthermore, a decrease in the current makes the wiring design of the drive apparatus simple, which enables a reduction in the size of the drive apparatus. For this reason, an increase in the supply voltage to the drive apparatus is highly demanded.

Meanwhile, if the supply voltage is increased, an electric power supply system that supplies power to the drive apparatus is required to have high insulation performance or to provide insulation between the system and the surrounding (e.g. the ground) that is high enough to allow the increase in the supply voltage. However, it is difficult to maintain such a high degree of insulation stably in some cases. Causes for this may include, for example, that the electric power supply system necessarily contains a factor that leads to a decrease in the insulation performance (but technically needs to be contained in the electric power supply system) and that there is an external factor outside of the electric power supply system. These factors prevent the aforementioned demand for increased supply voltage from being met.

For example, in the case of an electric power supply system in the form of a fuel cell system using electric power generated by a fuel cell, a cooling apparatus is generally used to cool the heat generated in electric power generation. However, the presence of the cooling apparatus necessarily causes a certain degree of deterioration in insulation between the fuel cell system and the surrounding.

The present invention has been made in view of the above described problem and has as an object to provide an electric power supply system that can achieve both an increase in the supply voltage and adequate insulation performance when supplying power to a drive apparatus.

To achieve the above object, according to the present invention, what is called an insulation type converter is provided between the drive apparatus and the electric power supply for it. The insulation type converter makes insulation of the drive apparatus and insulation of electric power supply independent from each other, and even if the electric power supply contains a factor(s) that can affect the insulation performance of the drive apparatus, the drive apparatus is not affected by that, and consequently a high voltage electric power can be supplied to the drive apparatus.

More specifically, according to the present invention, there is provided an electric power supply system equipped on a mobile body to supply electric power to a drive apparatus that functions as a drive source of the mobile body, comprising a first power source apparatus that generates electric power and supplies the electric power to said drive apparatus, a second power source apparatus that is provided separately from said first power source apparatus and supplies electric power to said drive apparatus, and an insulation type converter for system that is provided between an electric power supply section including at least one of said first power source apparatus and said second power source apparatus and a mobile body drive section including said drive apparatus and ensures insulation between these sections while transmitting electric power from said electric power supply section to said mobile body drive section.

As described above, the electric power supply system according to the present invention is equipped on a mobile body and supplies electric power to a drive apparatus that drives the mobile body. Since electrical connection between the mobile body and the surrounding (such as ground) is weak in some cases due to its mobility, adequate insulation between the drive apparatus and the mobile body must be ensured. Here, the mobile bodies include not only transportation means such as an automobile, train, and vessel but also all that moves such as a robot etc.

Electric power is supplied to the drive apparatus of the mobile body from the first power source apparatus and the second power source apparatus, which are power source apparatuses provided separately. While the first power source apparatus generates and supplies electric power, the second power source apparatus does not necessarily need to be one that generates electric power, but it may be a storage type power source apparatus.

When electrical power is supplied from the first power source apparatus and the second power source apparatus to the drive apparatus in a state in which the first power source apparatus and the second power source apparatus are electrically connected with the drive apparatus directly, if the degree of insulation of the first power source apparatus or the second power source apparatus is low due to some factor, it is difficult to supply electric power to the drive apparatus at a high voltage. In view of this, the entire electric power system composed of the power supply system according to the present invention and the drive apparatus is sectioned into an electrical power supply section including said first power source apparatus and/or said second power source apparatus that is difficult to keep in a highly insulated condition and a mobile body drive section that is easy to keep in a highly insulated condition, and the two sections are electrically connected by the insulation type converter for system, whereby the insulation performance of the mobile body drive section is prevented from being affected by insulation deterioration factors in the electric power supply section.

Thus, it is possible to make the supply voltage in said electric power supply section relatively low and to make the supply voltage in said mobile body drive section higher than the supply voltage in said electric power supply section, whereby an increase in the supply voltage in supplying power to the drive apparatus and adequate insulation performance of the electric power supply system can both be achieved.

In the above-described electric power supply system, in a case where the condition of insulation between said first power source apparatus and its surrounding is worse than a predetermined insulation condition, the first power source apparatus may be included in the electric power supply section. The first power source apparatus that generates electric power is generally equipped with a cooling apparatus that removes heat generated in electric power generation, and there is some possibility that the degree of insulation of the first power source apparatus is decreased for this reason. In such a case, an increase in the voltage of electric power supply to the drive apparatus and adequate insulation performance can be ensured by including the first power source apparatus in the aforementioned electric power supply section.

In the above-described electric power supply system, for example, said first power source apparatus may be a fuel cell that generates electric power by an electrochemical reaction of hydrogen gas and oxidant gas and supplies the electric power thus generated to said drive apparatus, and said second power source apparatus may be an electric power storage apparatus that has electric power storage means and supplies electric power stored by the electric power storage means to said drive apparatus. In the fuel cell, heat is generated in electric power generation, and a cooling apparatus (e.g. a radiator) is used to remove the generated heat. This can be a factor that hinders an increase in the degree of insulation of the fuel cell. Therefore, when the fuel cell is used to drive the drive apparatus, it is preferred that the fuel cell is provided in the aforementioned electric power supply section. Examples of the electric power storage apparatus include a battery and a capacitor etc.

In the above-described electric power system, said electric power supply section may include said first power source apparatus and said second power source apparatus, and said first power source apparatus and said second power source apparatus may be adapted to supply electric power to said drive apparatus in a parallel manner through said insulation type converter for system. Thus, including the first and the second power source apparatus that supply power to the drive apparatus together in the electric power supply section can eliminate factors leading to a decrease the degree of insulation associated with the power source apparatuses from the drive apparatus as much as possible. In this connection, electric power is supplied from the power source apparatuses to the drive apparatus in a parallel manner appropriately based on the electric power required by the drive apparatus and the electric power supply conditions of the respective power source apparatuses etc.

Furthermore, in the above-described electric power supply system, said first power source apparatus and said second power source apparatus may be electrically connected with each other through a DC to DC converter that enables regulation of electric power supplied to the primary side of said insulation type converter for system in accordance with electric power required by said drive apparatus, and said DC to DC converter may have a full-bridge configuration or a half-bridge configuration.

By arranging the first power source apparatus and the second power source apparatus in parallel through the DC to Dc converter, required electric power can be supplied to the drive apparatus reliably in a state suitable for output characteristics of the power source apparatuses. In some cases, it is difficult for the first power source apparatus that generates electric power to respond to the electric power requirement from the drive apparatus quickly due to its constitution. In such cases, electric power is supplied appropriately from the second power source apparatus through the DC to DC converter.

In the above described electric power supply system, said insulation type converter for system may have a primary coil provided on said electric power supply section side and a secondary coil provided on said mobile body drive section side, and said primary coil may be provided on either said first power source apparatus side or said second power source apparatus side of the DC to DC converter.

First, in the case where the primary coil is provided on the first power source apparatus side with respect to the DC to DC converter, electric power from the first power source apparatus is supplied to the drive apparatus through the insulation type converter for system without passing through the DC to DC converter. Therefore, it is possible to eliminate loss occurring in the DC to DC converter in this case. This is particularly advantageous in the case where the first power source apparatus is the principal power source apparatus for the drive apparatus. On the other hand, in the case where the primary coil is provided on the second power source apparatus side with respect to the DC to DC converter, it is possible, similarly, to eliminate loss occurring in the DC to DC converter when electric power is supplied from the second power source apparatus to the drive apparatus.

The above-described electric power supply apparatus may further include an insulation type converter for power source that is provided between said first power source apparatus and said second power source apparatus and ensures insulation between them while transmitting electric power between them. This configuration establishes independence of insulation between the power source apparatuses and constitutes a scheme of electric power supply to the drive apparatus without the use of the above-described DC to DC converter. In view of the fact that a DC to DC converter having a full-bridge or half-bridge configuration has a number of switching elements, use of the insulation type converter for power source can eliminate problems such as noise caused by the switching elements.

The aforementioned second power source apparatus may be provided not in the electric power supply section but in the mobile body drive section. In other words, the system may be configure in such a way that said electric power supply section includes said first power source apparatus, said mobile body drive section includes said second power source apparatus, said first power source apparatus supplies electric power to said drive apparatus through said insulation type converter for system, and said second power source apparatus supplies electric power to said drive apparatus in a parallel manner with said first power source apparatus without said insulation type converter for system. In the case where this configuration is adopted, it is preferred that the second power source apparatus does not contain a factor that decreases the degree of insulation of the drive apparatus. In this configuration, the second power source apparatus, which is disposed at a position closer the drive apparatus, supplies electric power to the drive apparatus in a passive manner that depends on the electric power generated by the first power source apparatus. On the other hand, since it is not needed to directly connect the first power source apparatus and the second power source apparatus having different power output characteristics, the aforementioned DC to DC converter and the insulation type converter for power source are unnecessary. Thus, the size of the overall electric power supply system can be made smaller.

In the electric power supply system having been described heretofore, said insulation type converter for system may have a primary coil provided on said electric power supply section side and a secondary coil provided on said mobile body drive section side, and the system may further include converter control means that changes an effective turns ratio of said primary coil and said secondary coil in accordance with electric power required by said drive apparatus. In the above-described insulation type converter for system, stepping-up of the supply voltage is performed in accordance with the aforementioned effective turns ratio between the primary coil and the secondary coil. Here, the effective turns ratio is the ratio of the number of turns of the primary coil and that of the secondary coil, which are involved in the voltage step-up in the insulation type converter for system. In the electric power supply system according to the present invention, the effective turns ratio is adjusted by the aforementioned converter control means so as to increase (or step up) the supplied voltage in the electric power supply section and supply electric power suitable for the required load to the drive apparatus.

More specifically, for example, said converter control means may change said effective turns ratio based on the relative ratio of electric power required by said drive apparatus and electric power generated by said first power source apparatus so that voltage conversion efficiency in said insulation type converter for system is maintained in a certain preferable condition. The voltage conversion efficiency (or the converter efficiency) of the insulation type converter for system depends on the turns ratio of the primary coil and the secondary coil. Therefore, the converter control means adjusts the effective turns ratio based on the aforementioned relative ratio so that the aforementioned preferable condition that provides more preferred conversion efficiency is achieved, thereby reducing loss in the insulation type converter for system.

### BRIEF DESCRIPTION OF THE DRAWINGS

FIG. 1 is a diagram showing the general configuration of a vehicle equipped with an electric power supply system (or a fuel cell system) according to the present invention.

FIG. 2 is a first diagram showing the general configuration of an electric power system that is equipped in the vehicle shown in FIG. 1 and configured to include the fuel cell system according to the present invention.

FIG. 3 is a chart showing a flow of electric power supply control for supplying electric power from the electric power supply section including the fuel cell to a drive motor in the electric power supply system shown in FIG. 2.

FIG. 4A is a graph showing a torque of the drive motor of the vehicle shown in FIG. 1.

FIG. 4B is a graph showing the relation between the number of rotations and the required power output of the drive motor of the vehicle shown in FIG. 1 and the voltage needed by the drive motor.

FIG. 5 is a second diagram showing the general configuration of an electric power system that is equipped in the vehicle shown in FIG. 1 and configured to include the fuel cell system according to the present invention.

FIG. 6 is a third diagram showing the general configuration of an electric power system that is equipped in the vehicle shown in FIG. 1 and configured to include the fuel cell system according to the present invention.

FIG. 7 is a fourth diagram showing the general configuration of an electric power system that is equipped in the vehicle shown in FIG. 1 and configured to include the fuel cell system according to the present invention.

FIG. 8 is a fifth diagram showing the general configuration of an electric power system that is equipped in the vehicle shown in FIG. 1 and configured to include the fuel cell system according to the present invention.

FIG. 9 is a sixth diagram showing the general configuration of an electric power system that is equipped in the vehicle shown in FIG. 1 and configured to include the fuel cell system according to the present invention.

FIG. 10 is a graph showing the relation between the voltage step-up ratio between the electric power supply section and the vehicle drive section and the converter efficiency of the insulation type converter for system in the electric power supply system shown in FIG. 9.

FIG. 11 is a chart showing a flow of electric power supply control for supplying electric power from the electric power supply section including the fuel cell to a drive motor in the electric power supply system shown in FIG. 9.

FIG. 12 is a seventh diagram showing the general configuration of an electric power system that is equipped in the vehicle shown in FIG. 1 and configured to include the fuel cell system according to the present invention.

FIG. 13 is a eighth diagram showing the general configuration of an electric power system that is equipped in the vehicle shown in FIG. 1 and configured to include the fuel cell system according to the present invention.

FIG. 14 is a ninth diagram showing the general configuration of an electric power system that is equipped in the vehicle shown in FIG. 1 and configured to include the fuel cell system according to the present invention.

FIG. 15 is a tenth diagram showing the general configuration of an electric power system that is equipped in the vehicle shown in FIG. 1 and configured to include the fuel cell system according to the present invention.

FIG. 16 is a eleventh diagram showing the general configuration of an electric power system that is equipped in the vehicle shown in FIG. 1 and configured to include the fuel cell system according to the present invention.

FIG. 17 is a graph showing the relation between the voltage step-up ratio between the electric power supply section and the vehicle drive section and the converter efficiency of the insulation type converter for system in the electric power supply system shown in FIG. 16.

FIG. 18 is a twelfth diagram showing the general configuration of an electric power system that is equipped in the vehicle shown in FIG. 1 and configured to include the fuel cell system according to the present invention.

FIG. 19 is a thirteenth diagram showing the general configuration of an electric power system that is equipped in the vehicle shown in FIG. 1 and configured to include the fuel cell system according to the present invention.

### BEST MODE FOR CARRYING OUT THE INVENTION

Embodiments of the electric power supply system according to the present invention will be described in detail with reference to the drawings. The electric power supply systems according to the embodiments are fuel cell systems that include a fuel cell and supply electric power to a drive motor that serves as a drive apparatus of an automobile or a mobile body.

### Embodiment 1

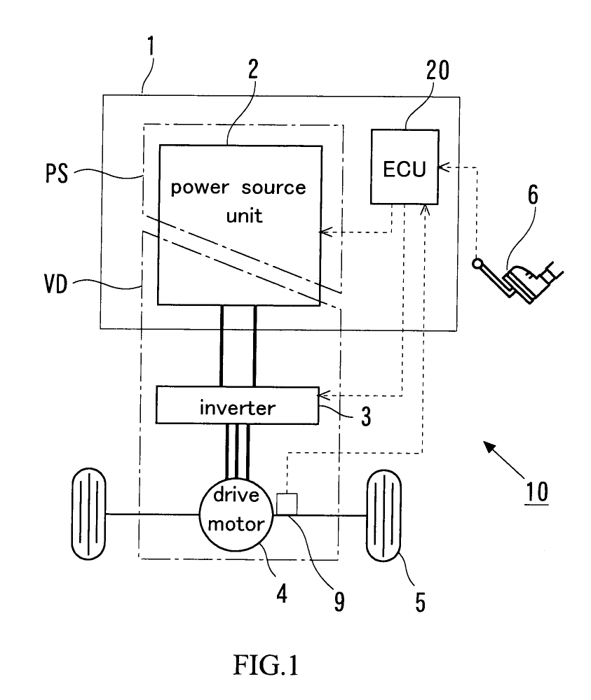

FIG. 1 schematically shows a vehicle 10 or a mobile body that is equipped with a fuel cell system 1, which constitutes the electric power supply system according to the present invention, and uses electric power supplied by the fuel cell system 1 as a drive source. The vehicle 10 is movable, or self-propelled as driving wheels 5 are driven by a drive motor (which will be simply referred to as the “motor” hereinafter) 4. The motor 4 is what is called a three phase alternating current motor, which is supplied with alternating current power from an inverter 3. The inverter 3 is supplied with direct current power from a power source unit 2 and converts the direct current power into alternating current power.

The vehicle 10 is further equipped with an electronic control unit (which will be hereinafter referred to as the “ECU”) 20, to which the aforementioned power source unit 2 and the inverter 3 are electrically connected, and electric power supply from the power source unit 2 and conversion into alternating current in the inverter 3 are controlled by it. The vehicle 10 is also provided with an accelerator pedal 6 by which an acceleration request by a user is entered. The ECU 20 is electrically informed of the opening degree of the accelerator pedal 6. Furthermore, the ECU 20 is electrically connected with an encoder 9 that detects the number of revolutions of the drive motor, and the ECU 20 detects the number of revolutions of the motor 4.

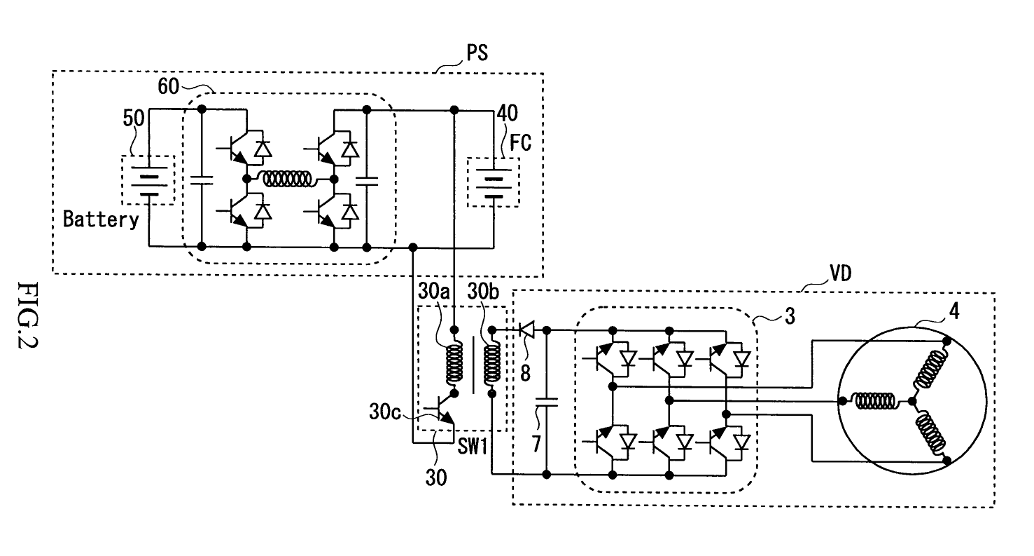

In the vehicle 10 having the above-described configuration, the fuel cell system 1 that controls electric power supply to the motor 4 mainly includes the power source unit 2 and the ECU 20. The power source unit 2 is provided with a fuel cell 40 (see FIG. 2 that will be mentioned later) that generates electric power by an electrochemical reaction of hydrogen gas and oxidant gas and other parts, and electric power thus produced is supplied to the motor 4. The fuel cell 40 is cooled by a radiator (not shown) to remove heat generated in the electric power generation. This makes technically difficult to maintain a relatively high degree of insulation between the fuel cell 40 itself and the surrounding. For this reason, the power source unit 2 including the fuel cell 40 is configured to supply a low-voltage electric power at a relatively low voltage value, for example at a supply voltage of approximately 300 V. On the other hand, a so-called high voltage type motor that can be driven by high-voltage electric power is used as the motor 4 with a view to achieve efficient driving with reduced copper loss etc. The driving voltage of the motor 4 is, for example, approximately 600 V.

In view of the above, according to the present invention, the vehicle 10 is sectioned, from the viewpoint of supply voltage, into a power supply section PS in which the supply voltage is low and a vehicle drive section VD in which the supplied voltage is high, and these sections are connected by an insulation type converter for system that will be described later. There is no direct electrical connection between the electric power supply section PS and the vehicle drive section VD, and they are insulated independently from each other by the insulation type converter for system. With the above-described electric system configuration of the vehicle 10, it is possible to keep the voltage supplied to the motor 4 relatively high to enhance the drive efficiency and to keep the insulation condition of the fuel cell system 1 and the motor 4 stably, whereby faults such as ground fault can be prevented from occurring.

In the following, details of the electric power system of the vehicle 10 will be described with reference to FIG. 2. FIG. 2 is a diagram showing the general configuration of the electric power system of the vehicle 10. First, the electric power supply section PS mainly includes a fuel cell (FC) 40, a battery 50, and a DC to DC converter 60, where the fuel cell 40 and the battery 50 are arranged with the DC to DC converter 60 between. In the fuel cell 40, hydrogen gas is supplied based on a command from the ECU 20 according to the opening degree of the accelerator pedal 6, namely according to the required power output of the motor 4, so that electric power is generated. The battery 50 is a power source apparatus having the function of storing electric power. The battery 50 can store the electric power generated by the fuel cell 40 and electric power returning from the motor 4 as regenerative energy. The DC to DC converter 60 is a full-bridge type converter in which four switching elements are arranged in a bridge configuration.

By connecting the fuel cell 40 and the battery 50 by the DC to DC converter 60 in this way, electric power can be supplied to the motor jointly using the power source apparatuses having different output characteristics. For example, when there is a delay of response in electric power generation in the fuel cell 40, the electric power can be supplemented by the battery 50 to appropriately supply the required electric power to the motor 4.

The vehicle drive section VD mainly includes a motor 4 in the form of a three phase alternating current motor, an inverter 3 that supplies three phase alternating current, a blocking diode 8 for protection of inverter circuit, and a condenser 7 for removing ripples.

As described above, the supply voltage in the electric power supply section PS is set to be smaller than the supply voltage in the vehicle drive section VD with a view to ensure insulation of the fuel cell 40. Therefore, the electric power supply section PS and the vehicle drive section VD are electrically connected by the insulation type converter for system 30 in such a way that independency of the insulation condition of each of them is maintained. The insulation type converter for system 30 is composed of a primary coil 30a (having a number of turns of N1) provided in the power supplying part, a secondary coil 30b (having a number of turns of N2) provided in the power receiving part, and a switching element 30c that performs switching of current flowing in the primary coil 30a. The primary coil 30a and the switching element 30c, which are connected in series with each other, are connected in parallel with the fuel cell 40 and connected to the DC to DC converter 60 on its fuel cell 40 side. On the other hand, the secondary coil 30b is connected in series between the blocking diode 8 and the inverter 3 in the vehicle drive section VD.

The insulation type converter for system 30 having the above-described configuration can maintain the insulation condition of the electric power supply section PS and the insulation condition of the vehicle drive section VD independently from each other by the effect of the primary coil 30a and the secondary coil 30b and can step up the voltage supplied from the fuel cell 40 or battery 50 to supply the stepped-up voltage to the motor 4 by stepping up the supplied voltage between the primary coil 30a and the secondary coil 30b. The primary side of the insulation type converter for system 30 is connected to the fuel cell 40, and accordingly no electric power passes through the DC to DC converter 60 when electric power is supplied from the fuel cell 40 to the motor 4. Therefore, electric power can be supplied from the fuel cell 40 to the motor 4 without energy loss in the converter.

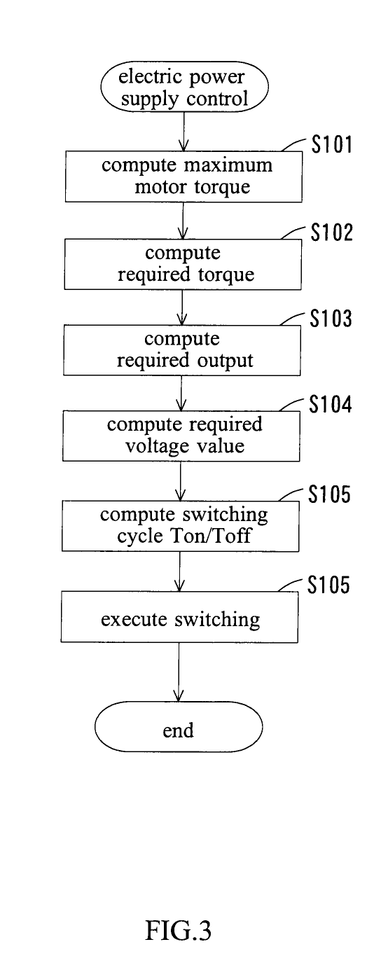

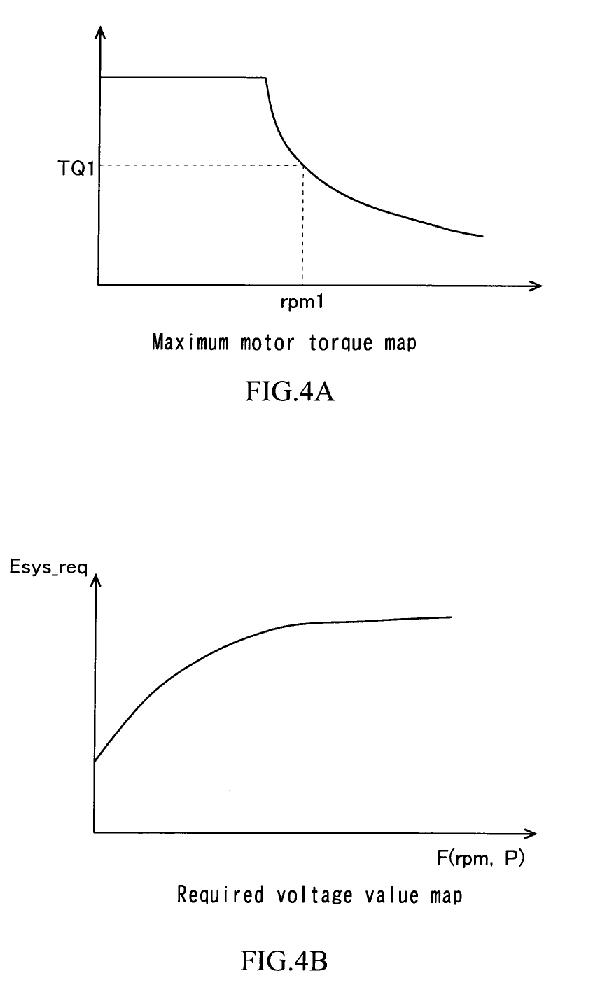

Here, the electric power supply control in the electric power system of the vehicle 10 shown in FIG. 2 will be described with reference to FIG. 3. The power supply control in this embodiment is a routine executed by the ECU 20. First in step S101, the maximum torque that the motor 4 can output at maximum, which is associated with the actual number of revolutions of the motor 4 detected by the encoder 9, is computed. Specifically, the ECU 20 has a maximum motor torque map that specifies the relationship between the number of revolutions of the motor 4 and the maximum torque associated therewith as shown in FIG. 4A, and the number of revolutions of the motor obtained as the detection value of the encoder 9 and the map are compared to compute the maximum torque of the motor 4 at that number of revolutions. For example as shown in FIG. 4A, when the number of revolutions of the motor is rpm1, the maximum motor torque is computed as TQ1. After completion of the process in step S101, the process proceeds to step S102.

In step S102, a required torque that the motor 4 is required to output is computed based on the opening degree of the accelerator pedal 6. If the full open position of the accelerator pedal 6, as defined herein, requires the maximum torque at the present number of revolutions of the motor 4, the required torque is computed according to the following equation:

(required torque)=(aforementioned maximum torque)×(coefficient corresponding to accelerator pedal opening degree),

where the coefficient is 100% at the full-open position and 0% at the full-close position. After completion of the process in step S102, the process proceeds to step S103.

In step S103, the required power output that the motor 4 is required to output is computed according to the following equation based on the results of computation in steps S101 and S102:

(required power output)=(required torque)×(number of revolutions of motor).

In step S104, the required voltage value to be supplied to the motor 4 is computed based on the required power output computed in step S103 and the number of revolutions of the motor 4. Specifically, the ECU 20 has a required voltage value map that specifies the relationship between a function F of the number of revolutions (rpm) of the motor 4 and the aforementioned required power output (P) and the required voltage value Esys_req as shown in FIG. 4B, and the required voltage value is computed by comparing the number of revolutions of the motor and the required power output with the map. As the number of revolutions of the motor 4 increases, its counter electromotive force increases, and therefore the required voltage value should increase. As the require power output increases, the required voltage value should increase in order to achieve the required power output with smaller current. The relationship between the function F and the required voltage reflects these points. After completion of the process of step S104, the process proceeds to step S105.

In S105, switching cycle Ton/Toff of the switching element 30c (where Ton is the time over which the switching element 30c is on, and Toff is the time over which the switching element 30c is off) in the insulation type converter for system 30 is computed based on the required voltage value Esys_req computed in step S104 and the fuel cell supply voltage Efc in the electric power generation by the fuel cell 40 performed in accordance with the opening degree of the accelerator pedal 6. The switching cycle determines the supply voltage step-up ratio of the insulation type converter for system 30 or the ratio of voltage step-up from the lower voltage in the electric power supply section PS to the higher voltage in the vehicle drive section VD. The switching cycle is computed according to the following equation:

Ton/Toff=(Esys_req/Efc)×(N1/N2).

After completion of the process of step S105, the process proceeds to step S106.

In step S106, on/off control of the switching element 30c of the insulation type converter for system 30 is executed in accordance with the switching cycle Ton/Toff computed in step S105, and then this control is terminated.

According to this control, high voltage electric power can be supplied to the motor, while the insulation condition of the electric power supply section PS including the fuel cell 40 and the battery 50 and the insulation condition of the vehicle drive section VD are maintained independently from each other. Consequently, it is possible to achieve highly efficient driving of the motor while preventing faults such as ground fault from occurring in the electric power system of the vehicle 10.

### Embodiment 2

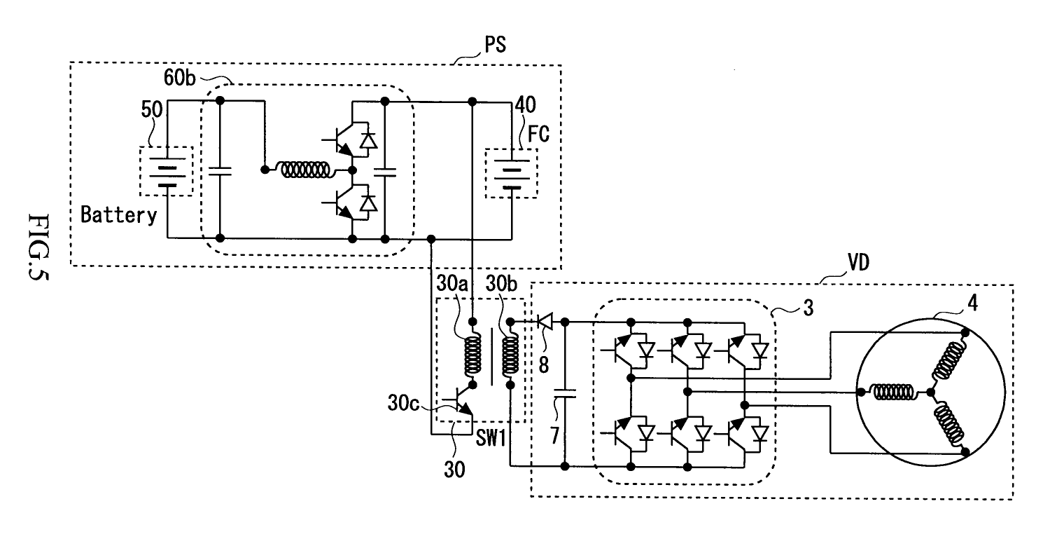

A second embodiment of the fuel cell system as an electric power supply system according to the present invention will be described with reference to FIG. 5. FIG. 5 is a diagram showing the general configuration of the electric power system of the vehicle 10. Components of the electric power system shown in FIG. 5 that are the same as the components of the electric power system shown in FIG. 2 are denoted by the same reference numerals, and detailed description thereof will be omitted. The electric power system shown in FIG. 5 differs from the electric power system shown in FIG. 2 in the DC to DC converter that connects the fuel cell 40 and the battery 50 in the electric power supply section PS.

The DC to DC converter used in this embodiment is a DC to DC converter 60b having what is called a half-bridge configuration. The voltage output regulated by this converter is different from that in the case of the converter having a full-bridge configuration, but the DC to DC converter 60b having a half-bridge configuration can also be used as long as the difference does not cause any trouble in regulating voltage characteristics of the fuel cell 40 and the battery 50. In this case also, it is possible to supply the motor 4 with a high-voltage electric power while maintaining the insulation condition of the electric power supply section PS including the fuel cell 40 and the battery 50 and the insulation condition of the vehicle drive section VD independently from each other, as is the case with the first embodiment.

### Embodiment 3

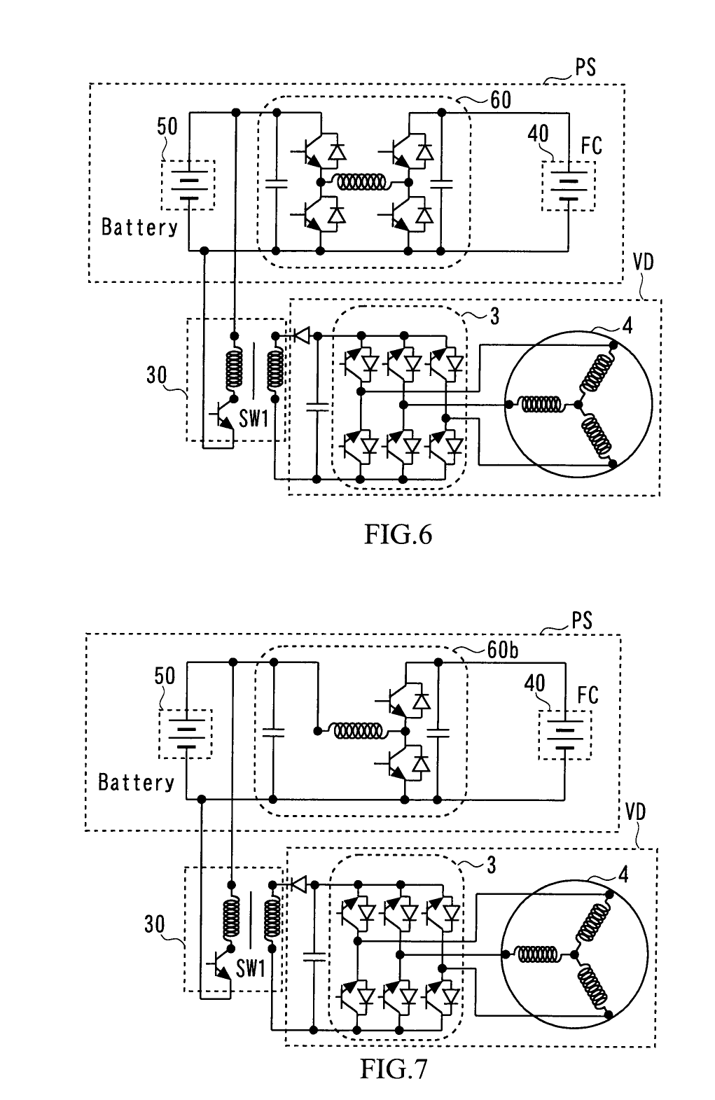

A third embodiment of the fuel cell system as an electric power supply system according to the present invention will be described with reference to FIGS. 6 and 7. FIGS. 6 and 7 are diagrams each showing the general configuration of the electric power system of the vehicle 10. Components of the electric power systems shown in FIGS. 6 and 7 that are the same as the components of the electric power system shown in FIG. 2 are denoted by the same reference numerals, and detailed description thereof will be omitted.

First, the electric power system shown in FIG. 6 differs from the electric power system shown in FIG. 2 in the position at which the insulation type converter for system 30 is connected in the electric power supply section PS. In this embodiment, the primary coil 30a of the insulation type converter for system 30 and the switching element 30c, which are connected in series with each other, are connected in parallel with the battery 50 and connected to the DC to DC converter 60 on its battery 50 side. Thus, the primary side of the insulation type converter for system 30 is connected to the battery 50, and accordingly no electric power passes through the DC to DC converter 60 when electric power is supplied from the battery 50 to the motor 4. Therefore, electric power can be supplied from the battery 50 to the motor 4 without energy loss in the converter.

Secondly, in the electric power system shown in FIG. 7, the DC to DC converter that connects the fuel cell 40 and the battery 50 in the electric power system shown in FIG. 6 has been replaced by a DC to DC converter 60b having a half-bridge configuration as with embodiment 2.

In the electric power systems shown in FIGS. 6 and 7 also, it is possible to supply the motor 4 with a high voltage electric power while maintaining the insulation condition of the electric power supply section PS including the fuel cell 40 and the battery 50 and the insulation condition of the vehicle drive section VD independently from each other, as is the case with the first embodiment.

### Embodiment 4

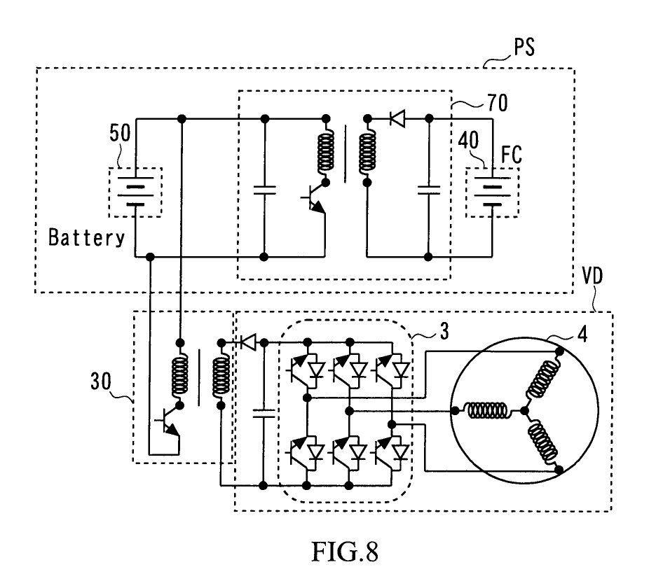

A fourth embodiment of the fuel cell system as an electric power supply system according to the present invention will be described with reference to FIG. 8. FIG. 8 is a diagram showing the general configuration of the electric power system of the vehicle 10. Components of the electric power system shown in FIG. 8 that are the same as the components of the electric power systems shown in FIGS. 2 and 6 are denoted by the same reference numerals, and detailed description thereof will be omitted. The electric power system shown in FIG. 8 differs from the electric power system shown in FIG. 6 in the portion that connects the fuel cell 40 and the battery 50 in the electric power supply section PS.

In this embodiment, the fuel cell 40 and the battery 50 is connected by an insulation type converter for power source 70, which is an insulation type converter similar to the above-described insulation type converter for system 30. Use of the insulation type converter 70 enables supply of electric power from the fuel cell 40 to the motor 4 with a simple configuration only by turning on/off the switching element in the insulation type converter for power source 70. In addition, the insulation condition of the fuel cell 40 and the insulation condition of the battery 50 can be maintained independently from each other, and the battery 50 can be prevented from being affected by factors that decrease the degree of insulation of the fuel cell 40 (such as the presence of the aforementioned radiator).

In the electric power system according to this embodiment also, it is possible to supply the motor 4 with a high voltage electric power while maintaining the insulation condition of the electric power supply section PS including the fuel cell 40 and the battery 50 and the insulation condition of the vehicle drive section VD independently from each other, as is the case with the first embodiment.

### Embodiment 5

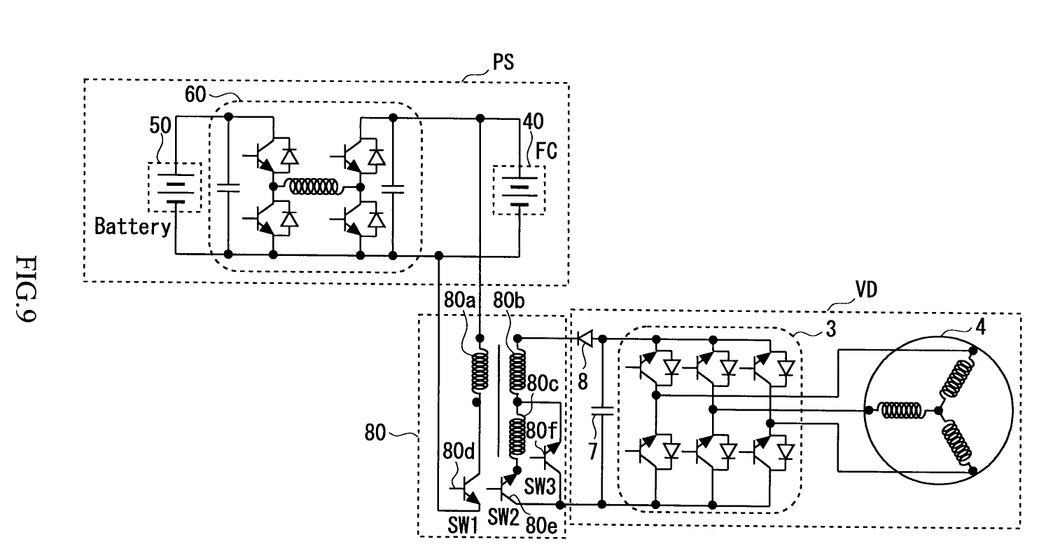

A fifth embodiment of the fuel cell system as an electric power supply system according to the present invention will be described with reference to FIGS. 9 to 11. FIG. 9 is a diagram showing the general configuration of the electric power system of the vehicle 10. Components of the electric power system shown in FIG. 9 that are the same as the components of the electric power systems shown in FIG. 2 are denoted by the same reference numerals, and detailed description thereof will be omitted. The electric power system shown in FIG. 9 differs from the electric power system shown in FIG. 2 in the insulation type converter for system.

In this embodiment, the electric power supply section PS and the vehicle drive section VD are connected by the insulation type converter for system 80. This insulation type converter for system 80 is of the same kind as the insulation type converter for system 30 described in the foregoing in the sense that it electrically connects the electric power supply section PS and the vehicle drive section VD while keeping them insulated from each other. The insulation type converter for system 80 includes, in its primary side, a primary coil 80a (which is equivalent to the above-described primary coil 30a) and a switching element 80d (which is equivalent to the above-described switching element 30c), as is the case with the insulation type converter for system 30. On the other hand, in its secondary side, the insulation type converter for system 80 includes a first secondary coil 80b and a second secondary coil 80c connected in series between a blocking diode 8 and an inverter 3. Furthermore, a switching element 80e is provided in series between the second secondary coil 80c and the inverter 3, and a switching element 80f is provided between the first secondary coil 80b and the inverter 3 so as to be connected in parallel with the series arrangement of the second secondary coil 80c and the switching element 80e.

In the insulation type converter for system 80 having the above-described configuration, the effective coil in the secondary side of the converter (i.e. the coil that is coupled with the primary coil 80a in a two-winding reactor to operate effectively) can be changed stepwise by switching the on/off states of the switching elements 80e and 80f. For example, when the switching element 80e is off and the switching element 80f is on, the effective secondary coil is composed of the first secondary coil 80b (which state will be hereinafter referred to as the “first selection state”). On the other hand, when the switching element 80e is on and the switching element 80f is off, the effective secondary coil is composed of the first secondary coil 80b and the second secondary coil 80c (which state will be hereinafter referred to as the “second selection state”).

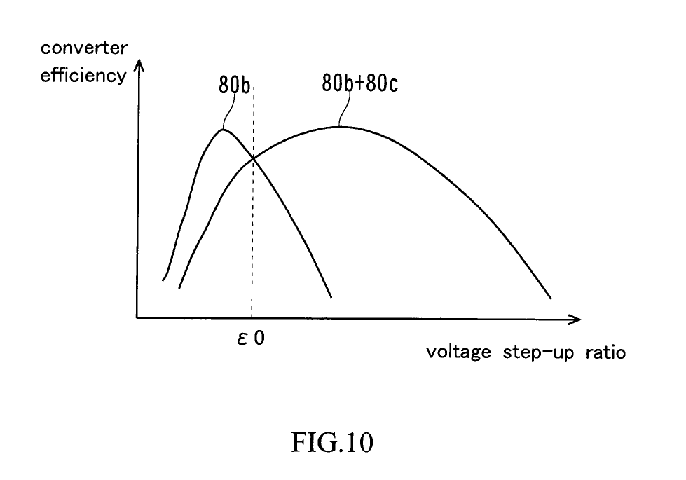

FIG. 10 shows the converter efficiency of the insulating type converter for system 80 in relation to the effective secondary coil. The horizontal axis of FIG. 10 represents the voltage step-up ratio between the primary side and the secondary side of the converter, and the vertical axis represents the converter efficiency of this converter. As the inductance of the effective secondary coil increases, the peak of the converter efficiency in relation to the voltage step-up ratio shifts to the higher voltage step-up ratios side. Consequently, in the second selection state the converter efficiency reaches its peak at a higher voltage step-up ratio than in the first selection state as will be seen in FIG. 10. Threshold ε0 of the voltage step-up ratio indicates the point at which the first selection state and the second selection state change their places in the order of superiority in terms of converter efficiency in relation to the voltage step-up ratio.

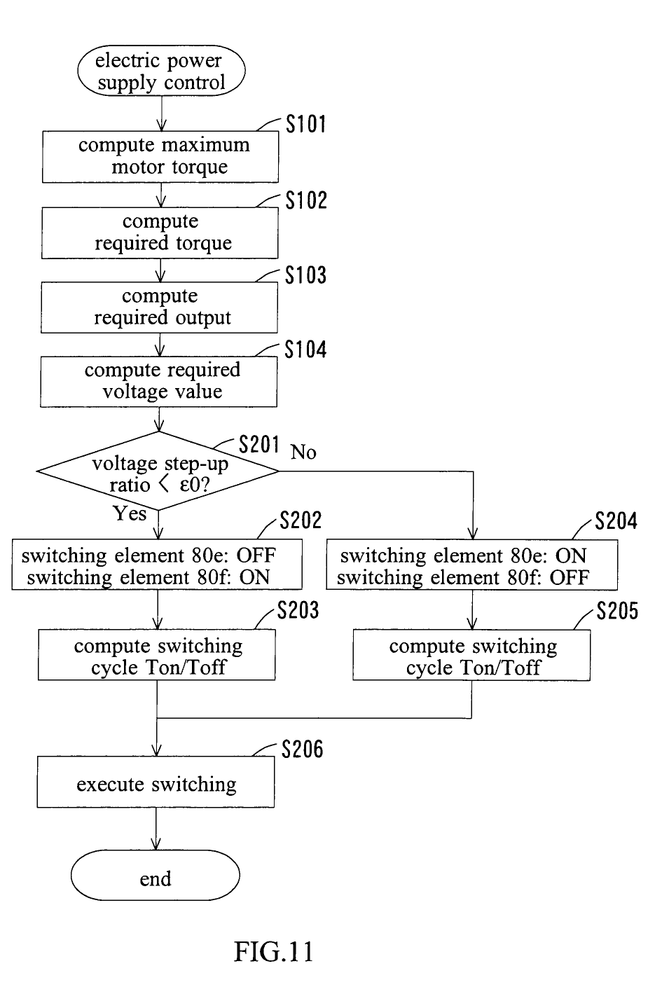

Thus, the effective coil is changed by the switching elements 80e, 80f in accordance with the voltage step-up ratio of the insulation type converter for system 80, whereby stepping-up of the supply voltage from the primary side to the secondary side can be achieved in a better converter efficiency condition. An electric power supply control for supplying electric power to the motor 4 while keeping a better converter efficiency condition will be described with reference to FIG. 11. The electric power supply control according to this embodiment is a routine executed by the ECU 20. The steps in which processes the same as those in the electric power supply control shown in FIG. 3 are denoted by the same reference numerals, and detailed description thereof will be omitted.

In the electric power supply control according to this embodiment, after completion of the process in step S104, the process proceeds to step S201. In step S201, a determination is made as to whether the voltage step-up ratio ε defined as the ratio of the required voltage value Esys_req to the fuel cell supply voltage Efc of the fuel cell 40 (i.e. the voltage of electric power generation in the fuel cell 40 performed according to the opening degree of the accelerator pedal 40) is lower than a predetermined threshold ε0 or not. This threshold ε0 is equivalent to threshold ε0 shown in FIG. 10. In other words, in step S201, a determination is made as to whether the first selection state or the second selection state is to be selected in view of the converter efficiency of the insulation type converter for system 80.

If it is determined in step S201 that the voltage step-up ratio ε is lower than the predetermined threshold ε0, namely if it is determined that the first selection state of the efficient coil is to be selected, the process proceeds to step S202, where the switching element 80e is turned off and the switching element 80f is turned on. On the other hand, if it is determined in step S201 that the voltage step-up ratio ε is not lower than the predetermined threshold ε0, namely if it is determined that the second selection state of the efficient coil is to be selected, the process proceeds to step S204, where the switching element 80e is turned on and the switching element 80f is turned off.

After completion of the process in step S202, the process proceeds to step S203. In step S203, the switching cycle Ton/Toff of the switching element 80d in the insulation type system converter for system 80 is computed based on the aforementioned required voltage value Esys_req and fuel cell supply voltage Efc. The definition of the switching cycle is the same as that in embodiment 1. In this case, since the effective secondary coil in the insulation type converter for system 80 is composed only of the first secondary coil 80b, the switching cycle is computed according to the following equation:

Ton/Toff=(Esys_req/Efc)×(N1/N2).

After completion of the process in step S203, the process proceeds to step S206.

On the other hand, after completion of the process in step S204, the process proceeds to step S205. In step S205, the switching cycle Ton/Toff of the switching element 80d in the insulation type system converter for system 80 is computed based on the aforementioned required voltage value Esys_req and fuel cell supply voltage Efc. In this case, since the effective secondary coil in the insulation type converter for system 80 is composed of the first secondary coil 80b and the second secondary coil 80c, the switching cycle is computed according to the following equation:

Ton/Toff=(Esys_req/Efc)×(N1/(N2+N3)).

After completion of the process in step S205, the process proceeds to step S206.

In step S206, on/off control of the switching element 80d of the insulation type converter for system 80 is executed in accordance with the switching cycle Ton/Toff computed in step S203 or S205, and then this control is terminated.

According to this control, high voltage electric power can be supplied to the motor 4, while the insulation condition of the electric power supply section PS including the fuel cell 40 and the battery 50 and the insulation state of the vehicle drive section VD are maintained independently from each other. Consequently, it is possible to achieve highly efficient driving of the motor while preventing faults such as ground fault from occurring in the electric power system of the vehicle 10. Furthermore, by adjusting the state of the switching elements in the insulation type converter for system 80 based on the voltage step-up ratio, the converter efficiency thereof can be kept in as good condition as possible.

### Embodiment 6

A sixth embodiment of the fuel cell system as an electric power supply system according to the present invention will be described with reference to FIGS. 12 to 15. These drawings are diagrams each showing the general configuration of the electric power system of the vehicle 10, which is a modification of the above described embodiment 5. Therefore, components of the electric power system shown in these drawings that are the same as the components of the electric power systems shown in FIG. 9 are denoted by the same reference numerals, and detailed description thereof will be omitted. First, in the electric power system shown in FIG. 12, the DC to DC converter section that connects the fuel cell 40 and the battery 50 is composed of a DC to DC converter 60b having a half-bridge configuration as is the case with the above-described embodiment 2. The configuration other than this is the same as the above-described embodiment 5.

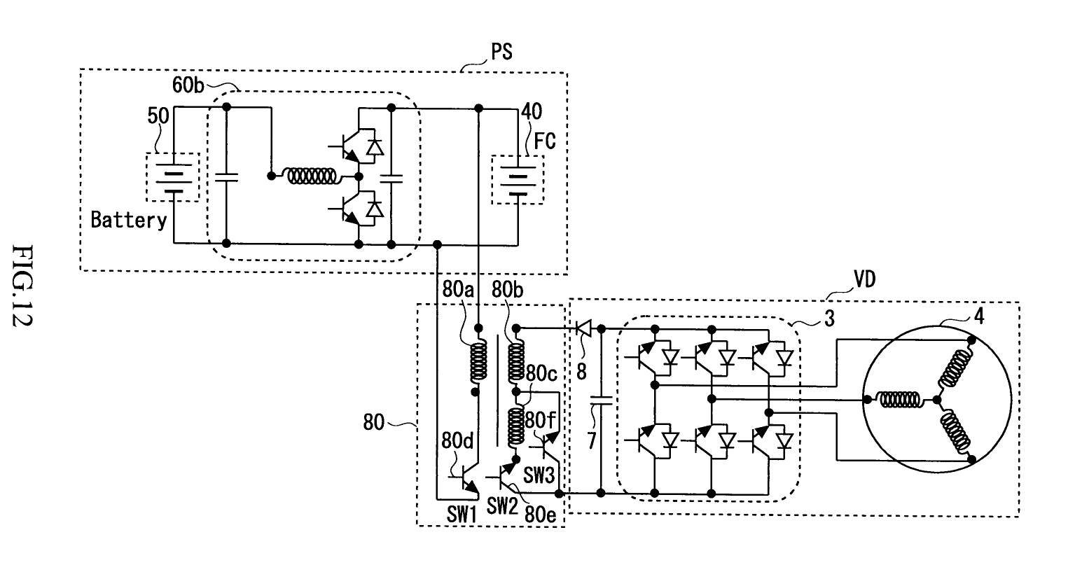

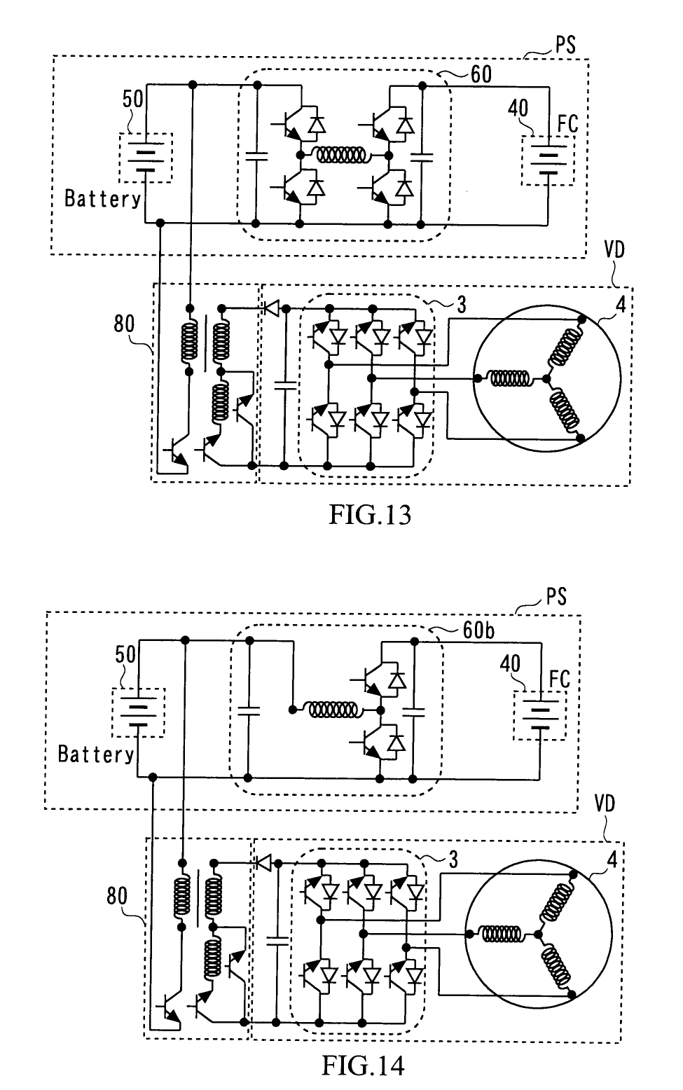

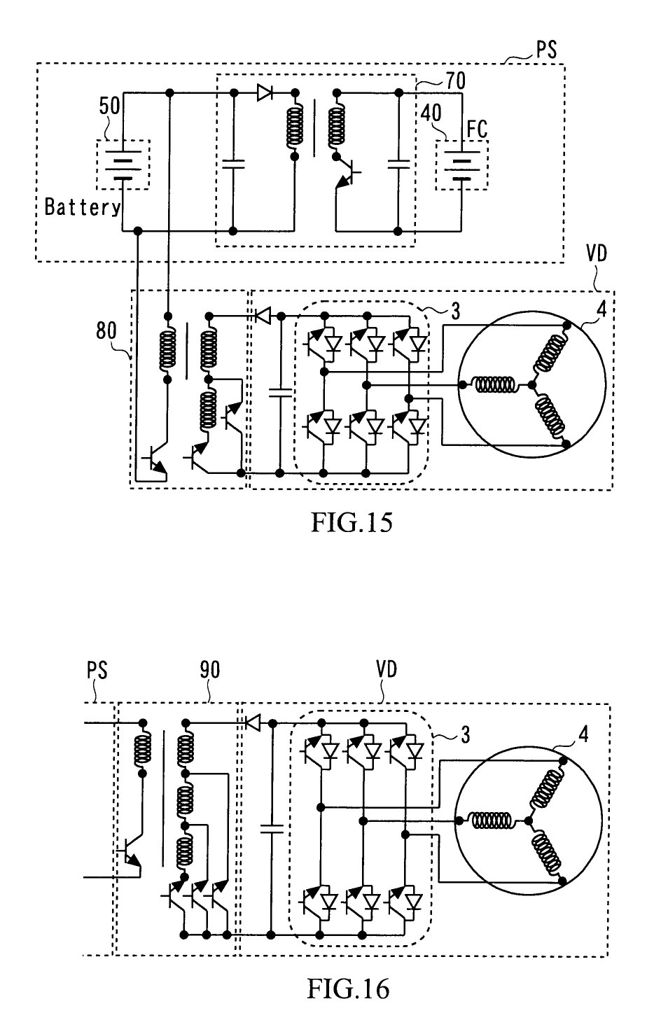

Next, in the electric power system shown in FIG. 13, the primary side of the insulation type converter for system 80 is connected to the battery 50 as with the system shown in FIG. 6 according to the above-described embodiment 3. The configuration other than this is the same as the above-described embodiment 5. In the electric power system shown in FIG. 14, the DC to DC converter that connects the fuel cell 40 and the battery 50 in the electric power system shown in FIG. 13 has been replaced by a DC to DC converter 60b having a half-bridge configuration as is the case with the system shown in FIG. 7 according to the above-described embodiment 3. The configuration other than this is the same as the above-described embodiment 5. In the electric power system shown in FIG. 15, the portion that connects the fuel cell 40 and the battery 50 is composed of an insulation type converter for power source 70 as is the case with the above-described embodiment 4. The configuration other than this is the same as the above-described embodiment 5.

According to the electric power supply systems of the vehicle 10 having the above-described configurations, high voltage electric power can be supplied to the motor 4, while the insulation condition of the electric power supply section PS including the fuel cell 40 and the battery 50 and the insulation condition of the vehicle drive section VD are maintained independently from each other as is the case with embodiment 5. Furthermore, the converter efficiency of the insulation type converter for system 80 can be kept in as good condition as possible.

### Embodiment 7

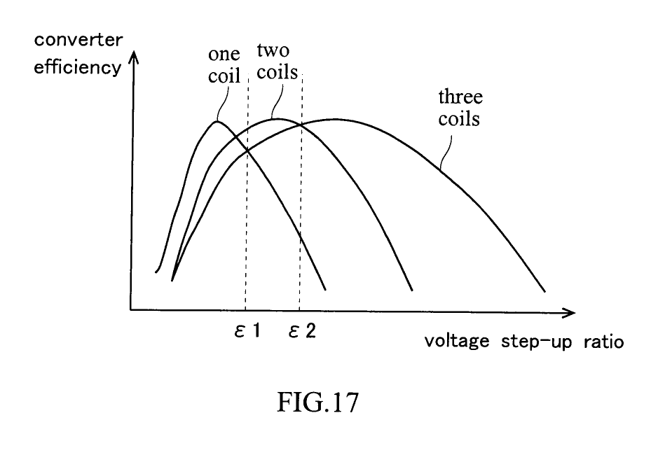

A seventh embodiment of the fuel cell system as an electric power supply system according to the present invention will be described with reference to FIGS. 16 and 17. FIG. 16 is a diagram showing the general configuration of the electric power system of the vehicle 10, which is a modification of the above-described embodiment 5. Therefore, components of the electric power system shown in FIG. 5 that are the same as the components of the electric power systems shown in FIG. 9 are denoted by the same reference numerals, and detailed description thereof will be omitted.

In the electric power supply system shown in FIG. 16, the electric power supply section PS and the vehicle drive section VD are connected by an insulation type converter for system 90, which is an insulation type converter similar to the above-described insulation type converter for system 80. In the insulation type converter for system 90, the effective coil can be selected by switching the on/off states of switching elements provided on the secondary side of the converter as with the insulation type converter for system 80. The insulation type converter for system 90 is provided with three secondary coils and three switching elements correspondingly on the secondary side, as shown in FIG. 16.

Therefore, the change in the converter efficiency relative to the voltage step-up ratio can be switched in three ways by switching the on/off states of the switching elements, as shown in FIG. 17. Thus, with threshold values ε1 and ε2 of the voltage step-up ratios; (1) when the voltage step-up ratio is lower than ε1, one coil is selected to constitute the effective coil, (2) when the voltage step-up ratio is not lower than ε1 and lower than ε2, two coils are selected to constitute the effective coil, and (3) when the voltage step-up ratio is lower than ε2, three coils are selected to constitute the effective coil, whereby the converter efficiency of the insulation type converter for system 90 can be kept in as good condition as possible. The switching cycle Ton/Toff of the switching element on the primary side of the insulation type converter for system 90 is appropriately set in accordance with the turns ratio of the primary coil and the effective secondary coil.

In the fuel cell system according to the present invention, the secondary coil of the insulation type converter for system is not limited to the two-coil type or the three-coil type described in embodiments 5 and 7, but it may include four or more multiple coils. In addition, the arrangement of the switching elements is not limited to the arrangements described in embodiments 5 to 7, but any arrangement of the switching elements may be adopted as long as the effective secondary coil can be selected appropriately in view of the converter efficiency.

### Embodiment 8

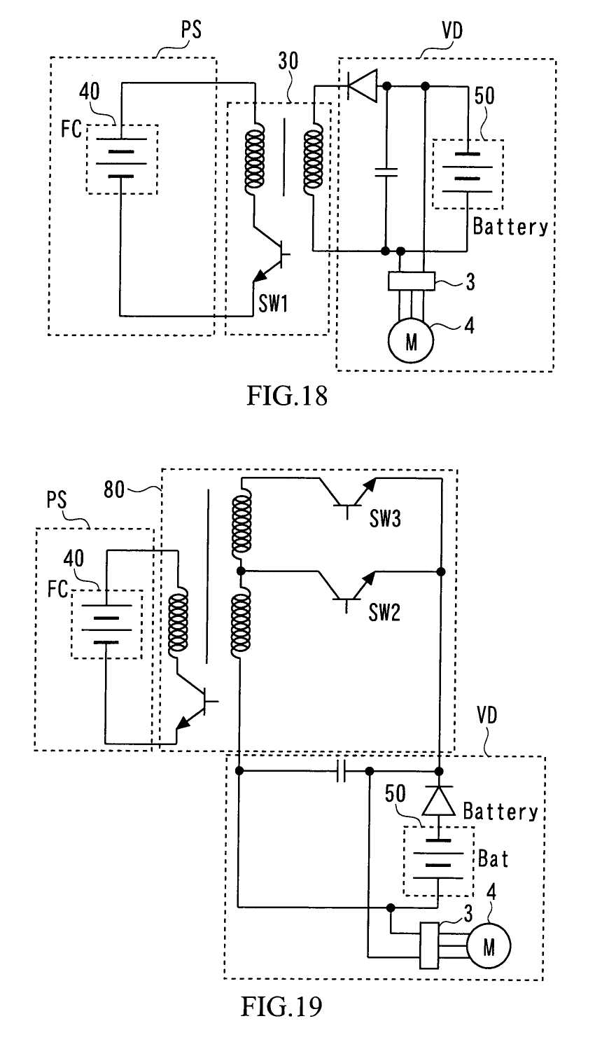

An eighth embodiment of the fuel cell system as an electric power supply system according to the present invention will be described with reference to FIG. 18. FIG. 18 is a diagram showing the general configuration of the electric power system of the vehicle 10. Components of the electric power system shown in FIG. 18 that are the same as the components of the electric power system shown in FIG. 2 are denoted by the same reference numerals, and detailed description thereof will be omitted. The electric power system shown in FIG. 18 differs from the electric power system shown in FIG. 2 in that the battery 50 is provided not in the electric power supply section PS but in the vehicle drive section VD. Therefore, in this embodiment, the above-described DC to DC converter or the insulation type converter for power source that connects the fuel cell 40 and the battery 50 is not provided between them.

In this embodiment, the battery 50 is provided in the vehicle drive section VD. This requires, as a precondition, that a relatively high degree of insulation of the battery 50 is maintained. In the electric power system of the vehicle 10 having the above-described configuration, since the fuel cell 40 and the battery 50 are not connected by a DC to DC converter etc, it is difficult to control the power output allocation minutely. That is, if the output of the fuel cell 40 is used as the main power output, the output of the battery 50 is passive, and the power output allocation among them will take its natural course. On the other hand, since the need for the DC to DC converter or the like is eliminated, the overall fuel cell system can be made smaller, and in addition high-voltage electric power can be supplied to the motor 4, while the insulation condition of the electric power supply section PS and the insulation condition of the vehicle drive section VD are maintained independently from each other, as a matter of course.

The electric power supply control shown in FIG. 3 can also be applied to the electric power system shown in FIG. 18.

### Embodiment 9

A ninth embodiment of the fuel cell system as an electric power supply system according to the present invention will be described with reference to FIG. 19. FIG. 19 is a diagram showing the general configuration of the electric power system of the vehicle 10, which is a modification of the above-described embodiment 8. Therefore, components of the electric power system shown in FIG. 19 that are the same as the components of the electric power system shown in FIG. 18 are denoted by the same reference numerals, and detailed description thereof will be omitted.

The electric power system shown in FIG. 19 differs from the electric power system of the above-described embodiment 8 shown in FIG. 18 in that the electric power supply section PS and the vehicle drive section VD are connected by an insulation type converter for system 80 in which the effective secondary coil can be switched as described in the above-described embodiment 5. The configuration other than this is the same. The electric power supply control shown in FIG. 11 can also be applied to this electric power system.

Thus, high voltage electric power can be supplied to the motor 4, while the insulation condition of the electric power supply section PS and the insulation condition of the vehicle drive section VD are maintained independently from each other. Furthermore, by adjusting the state of the switching elements in the insulation type converter for system 80 based on the voltage step-up ratio, the converter efficiency thereof can be kept in as good condition as possible.

### INDUSTRIAL APPLICABILITY

As described above, according to the electric power supply system of the present invention, an increase in the supply voltage and adequate insulation performance of the drive apparatus and the system can both be achieved when supplying power to a drive apparatus.

1: An electric power supply system equipped on a mobile body to supply electric power to a drive apparatus that functions as a drive source of the mobile body, comprising:
a fuel cell that generates electric power by an electrochemical reaction of hydrogen gas and oxidant gas and supplies the electric power generated by the electric power generation to said drive apparatus;
an electric power storage apparatus that is provided separately from said fuel cell, has an electric power storage unit, and supplies electric power stored by the electric power storage unit to said drive apparatus; and
an insulation type converter for system that is provided between an electric power supply section including said fuel cell and said electric power storage apparatus and a mobile body drive section including said drive apparatus and ensures insulation between these sections while transmitting electric power from said electric power supply section to said mobile body drive section, wherein
a radiator for cooling heat generated in electric power generation is connected to said fuel cell, and said fuel cell and said electric power storage apparatus supply electric power to said drive apparatus through said insulation type converter for system in a parallel manner.

2-5. (canceled)

6: An electric power supply system according to claim 1, wherein said fuel cell and said electric power storage apparatus are electrically connected with each other through a DC to DC converter that enables regulation of electric power supplied to a primary side of said insulation type converter for system in accordance with electric power required by said drive apparatus, and said DC to DC converter has a full-bridge configuration or a half-bridge configuration.

7: An electric power supply system according to claim 6, wherein said insulation type converter for system has a primary coil provided on said electric power supply section side and a secondary coil provided on said mobile body drive section side, and said primary coil is provided on either said fuel cell side or said electric power storage apparatus side of the DC to DC converter.

8: An electric power supply system according to claim 1, further comprising an insulation type converter for power source that is provided between said fuel cell and said electric power storage apparatus and ensures insulation between them while transmitting electric power between them.

9: An electric power supply system equipped on a mobile body to supply electric power to a drive apparatus that functions as a drive source of the mobile body, comprising:
a fuel cell that generates electric power by an electrochemical reaction of hydrogen gas and oxidant gas and supplies the electric power generated by the electric power generation to said drive apparatus;
an electric power storage apparatus that is provided separately from said fuel cell, has an electric power storage unit, and supplies electric power stored by the electric power storage unit to said drive apparatus; and
an insulation type converter for system that is provided between an electric power supply section including said fuel cell and a mobile body drive section including said electric power storage apparatus and said drive apparatus and ensures insulation between these sections while transmitting electric power from said electric power supply section to said mobile body drive section, wherein
a radiator for cooling heat generated in electric power generation is connected to said fuel cell, said fuel cell supplies electric power to said drive apparatus through said insulation type converter for system, and said electric power storage apparatus supplies electric power to said drive apparatus in a parallel manner with said fuel cell without said insulation type converter for system.

10: An electric power supply system according to claim 1, wherein said insulation type converter for system has a primary coil provided on said electric power supply section side and a secondary coil provided on said mobile body drive section side, and the system further comprises a converter control unit that changes an effective turns ratio of said primary coil and said secondary coil in accordance with electric power required by said drive apparatus.

11: An electric power supply system according to claim 10, wherein said converter control unit changes said effective turns ratio based on a relative ratio of electric power required by said drive apparatus and electric power generated by said fuel cell so that voltage conversion efficiency in said insulation type converter for system is maintained in a certain preferable condition.

12: An electric power supply system according to claim 9, wherein said insulation type converter for system has a primary coil provided on said electric power supply section side and a secondary coil provided on said mobile body drive section side, and the system further comprises a converter control unit that changes an effective turns ratio of said primary coil and said secondary coil in accordance with electric power required by said drive apparatus.

13: An electric power supply system according to claim 12, wherein said converter control unit changes said effective turns ratio based on a relative ratio of electric power required by said drive apparatus and electric power generated by said fuel cell so that voltage conversion efficiency in said insulation type converter for system is maintained in a certain preferable condition.
